(19) United States
(12) Patent Application Publication
(10) Pub. No.: US 2011/0271195 A1
(43) Pub. Date: Nov. 3, 2011

(54) METHOD AND APPARATUS FOR ALLOCATING CONTENT COMPONENTS TO DIFFERENT HARDWARD INTERFACES

(75) Inventors: Raja Bose, Mountain View, CA (US); Jorg Brakensiek, Mountain View, CA (US); Keun-Young Park, Mountain View, CA (US)

(73) Assignee: NOKIA CORPORATION, Espoo (FI)

(21) Appl. No.: 13/098,437

(22) Filed: Apr. 30, 2011

Related U.S. Application Data
(60) Provisional application No. 61/329,861, filed on Apr. 30, 2010.

(51) Int. Cl. G06F 3/01

(52) U.S. Cl. 715/733

(57) ABSTRACT

A method and apparatus are described that facilitate mobile device interoperability with a remote environment. A method may be provided that may determine, for each of a plurality of content components of a user interface, a respective hardware interface via which to transmit the content component. The method may also generate meta-information associated with at least one of the content components to facilitate recomposition of the content component and may cause the plurality of content components and the meta-information to be transmitted via the respective hardware interfaces with at least two of the content components being transmitted via different hardware interfaces. A method may also be provided that receives a plurality of streams of content components and meta-information via different respective hardware interfaces, recomposes the content components in accordance with the meta-information to form a unified user interface and causes a display to be presented of the unified user interface.

### RELATED APPLICATION

This application claims priority to U.S. Application No. 61/329681 filed Apr. 30, 2010, which is incorporated herein by reference in its entirety.

### TECHNICAL FIELD

Embodiments of the present invention relate generally to mobile terminal interoperability with a remote environment or remote client, and, more particularly, relate to a method and apparatus for associating content components with different hardware interfaces to facilitate exchange between a mobile terminal and the remote environment.

### BACKGROUND

Mobile computing devices continue to evolve such that the computing devices are capable of supporting new and powerful applications. Examples include location and mapping technologies (e.g., via Global Positioning System (GPS)), media player technologies (e.g., audio and video), web browsing technologies, gaming technologies, and the like. Mobile computing devices or mobile terminals, such as mobile phones, smart phones, personal digital assistants are evolving into personal media and entertainment centers in the sense that the devices are able to store and present a considerable amount of multimedia content. Moreover, many mobile computing devices support rich interactive games including those with three dimensional graphics.

However, due to the inherently small screen sizes and form factors of mobile computing devices, the user experience can be compromised when using rich applications. As such, solutions have been developed for interfacing a mobile computing device with a remote environment, such as a vehicle head unit, a meeting room, a home living room, etc., that, for example, includes a larger display or a more convenient user interface. As a consequence, the features and capabilities of the mobile component device may be projected into the remove environment and appear as inherent capabilities of the remote environment. The interfacing between the mobile computing device and the remote environment may occur upon entry of the mobile computing device into the remove environment However, connecting a mobile computing device to a remote environment often introduces latency to the user experience or otherwise diminishes the quality of service (QoS). These issues may be exacerbated in instances in which a number of different types of content are provided by the mobile computing device to the remote environment since the different types of content may have different network resource requirements, e.g., bandwidth, latency, QoS, etc.

### BRIEF SUMMARY

Example methods, apparatus and computer program products are therefore described that facilitate mobile device interoperability with a remote environment. In this regard, the method, apparatus and computer program product of example embodiments facilitate the provision of different types of content to the remote environment in a manner that satisfies their different network resource requirements. Thus, the method, apparatus and computer program product of example embodiments permit the user experience to be replicated in the remote environment by accommodating the different network resource requirements of the different types of content.

In one embodiment, a method is provided that determines, for each of a plurality of content components of a user interface, a respective hardware interface via which to transmit the content component. The method may also generate meta-information associated with at least one of the content components to facilitate recomposition of the content component following transmission. Further, the method may cause the plurality of content components and the meta-information to be transmitted via the respective hardware interfaces. In this regard, at least two of the content components may be transmitted via different hardware interfaces.

The method of one embodiment may also include splitting a unified user interface into a plurality of content components based upon content type, prior to determining the respective hardware interfaces via which to transmit the content components. For example, the splitting of the unified user interface may include the separation of a control stream from a user interface stream. If desired, the user interface stream may, in turn, be further split into its constituent content components, e.g., RGB, Video, OpenGL commands, etc. The method of one embodiment may embed the meta-information in a common stream with the respective content component. In one embodiment, the determination of the respective hardware interfaces may include determining the respective hardware interfaces based upon one or more network resource requirements of the respective content components. Additionally, the determination of the respective hardware interfaces may include the determination of the respective hardware interfaces based upon the quality of service of the respective hardware interfaces.

In another embodiment, an apparatus is provided that includes at least one processor and at least one memory including computer program code. The at least one memory and the computer program code are configured to, with the processor, cause the apparatus to determine, for each of a plurality of content components of a user interface, a respective hardware interface via which to transmit the content component. The at least one memory and the computer program code may also be configured to, with the processor, cause the apparatus to generate meta-information associated with at least one of the content components to facilitate recomposition of the content components following transmission. Further, the at least one memory and the computer program code may be configured to, with the processor, cause the apparatus to cause the plurality of content components and the meta-information to be transmitted via the respective hardware interfaces. In this regard, at least two of the content components may be caused to be transmitted via different hardware interfaces.

The memory and the computer program code may be further configured to, with the processor, cause the apparatus to split a unified user interface into a plurality of content components based upon content type, prior to determining the respective hardware interfaces via which to transmit the content components. For example, the unified user interface may be split by separating a control stream from a user interface stream. The memory and the computer program code may be further configured to, with the processor, cause the apparatus to embed the meta-information in a common stream with the respective content component. The memory and the computer program code may be further configured to, with the processor, cause the apparatus to determine the respective hardware interfaces by determining the respective hardware interfaces based upon one or more network resource requirements of the respective content components. Additionally, the determination of the respective hardware interfaces may be based upon the quality of service of the respective hardware interfaces.

A computer program product is provided in accordance with one embodiment that includes at least one computer-readable storage medium having computer-executable program code portions stored therein. The computer-executable program code portions may include program code instructions for determining, for each of a plurality of content components of a user interface, a respective hardware interface via which to transmit the content component. The computer-executable program code portions may also include program code instructions for generating meta-information associated with at least one of the content components to facilitate recomposition of the content components following transmission and program code instructions for causing the plurality of content components and the meta-information to be transmitted via the respective hardware interfaces. For example, at least two of the content components may be caused to be transmitted via different hardware interfaces.

The computer-executable program code portions may also include program code instructions for splitting the unified user interface into a plurality of content components based upon content type prior to determining the respective hardware interfaces via which to transmit the content components. For example, the unified user interface may be split by separating a control stream from a user interface stream. The computer-executable program code portions may include program code instructions for embedding the meta-information in a common stream with the respective content component. The program code instructions for determining the respective hardware interfaces may include program code instructions for determining the respective hardware interfaces based upon one or more network resource requirements of the respective content components. Additionally, the respective hardware interfaces may be determined based upon the quality of service of the respective hardware interfaces.

An apparatus is also provided in accordance with one embodiment that includes means for determining, for each of a plurality of content components of a user interface, a respective hardware interface via which to transmit the content component. The apparatus of this embodiment may also include means for generating meta-information associated with at least one of the content components to facilitate recomposition the content components following transmission and means for causing the plurality of content components and the meta-information to be transmitted via the respective hardware interfaces. For example, at least two of the content components may be transmitted via different hardware interfaces.

The apparatus may also include means for splitting a unified user interface into a plurality of content components based upon content type prior to determining the respective hardware interfaces via which to transmit the content components. In this regard, the means for splitting the unified user interface may include means for separating a control stream from a user interface stream. The apparatus of one embodiment may also include means for embedding the meta-information in a common stream with the respective content component. The means for determining the respective hardware interfaces may include means for determining the respective hardware interfaces based upon one or more network resource requirements of the respective content components. For example, the means for determining the respective hardware interfaces may be based upon the quality of service of the respective hardware interfaces.

In another embodiment, a method is provided that receives a plurality of streams of content components and meta-information via different respective hardware interfaces, recomposes the content components in accordance with the meta-information to form a unified user interface and causes a display to be presented in accordance with the unified user interface. For example, receiving the plurality of streams may include receiving a control stream and a user interface stream via different hardware interfaces. In addition, the method of one embodiment may include causing feedback to be provided regarding the quality of service of the respective hardware interfaces.

An apparatus is provided in accordance with another embodiment that includes at least one processor and at least one memory including computer program code. In this embodiment, the at least one memory and the computer program code are configured to, with the processor, cause the apparatus to at least receive the plurality of streams of content components and meta-information via different respective hardware interfaces, recompose the content components in accordance with the meta-information to form a unified user interface and cause a display to be presented in accordance with the unified user interface. In regards to receiving the plurality of streams, the memory and the computer program code may be further configured to, with the processor, cause the apparatus to receive a control stream and a user interface stream via different hardware interfaces. The memory and the computer program code of one embodiment may be further configured to, with the processor, cause the apparatus to cause feedback to be provided regarding the quality of service of the respective hardware interfaces.

A computer program product is provided in accordance with another embodiment that includes at least one computer-readable storage medium having a computer-executable program code portions stored therein. The computer-executable program code portions include program code instructions for receiving a plurality of streams of content components and meta-information via different respective hardware interfaces, recomposing the content components in accordance with the meta-information to form a unified user interface and causing a display to be presented in accordance with the unified user interface. The program code instructions for receiving the plurality of streams may include program code instructions for receiving a control stream and a user interface stream via different hardware interfaces. the computer-executable program code portions may also include program code instructions for causing feedback to be provided regarding the quality of service of the respective hardware interfaces.

An apparatus may be provided in accordance with one embodiment that includes means for receiving a plurality of streams of content components and meta-information via different respective hardware interfaces, means for recomposing the content components in accordance with the meta-information to form a unified user interface and means for causing a display to be presented in accordance with the unified user interface. The means for receiving a plurality of streams may include means for receiving a control stream and a user interface stream via different hardware interfaces. The apparatus of one embodiment may also include means for causing feedback to be provided regarding the quality of service of the respective hardware interfaces.

By separately determining the hardware interface via which to transmit each content component, the content components may be associated with different hardware interfaces based upon, for example, the network resource requirements of the respective content components. By matching or otherwise correlating the network resource requirements of the respective content components with the performance offered by the respective hardware interfaces, the content components may be transmitted and then recomposed in an efficient and effective way such that the user experience in the remote environment may be improved.

### BRIEF DESCRIPTION OF THE SEVERAL VIEWS OF THE DRAWING(S)

Having thus described embodiments of the present invention in general terms, reference will now be made to the accompanying drawings, which are not necessarily drawn to scale, and wherein:

FIG. 1 illustrates one example of the communication system according to an example embodiment of the present invention;

FIG. 2 illustrates a schematic diagram of an apparatus according to an example embodiment of the present invention;

FIG. 3 is a schematic representation of the transfer of different content components via different hardware interfaces in accordance with one embodiment of the present invention;

FIG. 4 is a block diagram illustrating operations performed by a server device transmitting content components and a client device receiving the content components in accordance with one example embodiment of the present invention;

FIG. 5 is a flowchart illustrating operations performed in order to cause content components to be transmitted via different hardware interfaces in accordance with one example embodiment of the present invention; and

FIG. 6 is a flowchart illustrating operations performed in order to recompose the unified user interface from a plurality of streams of content components received via different respective hardware interfaces in accordance with an example embodiment to the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

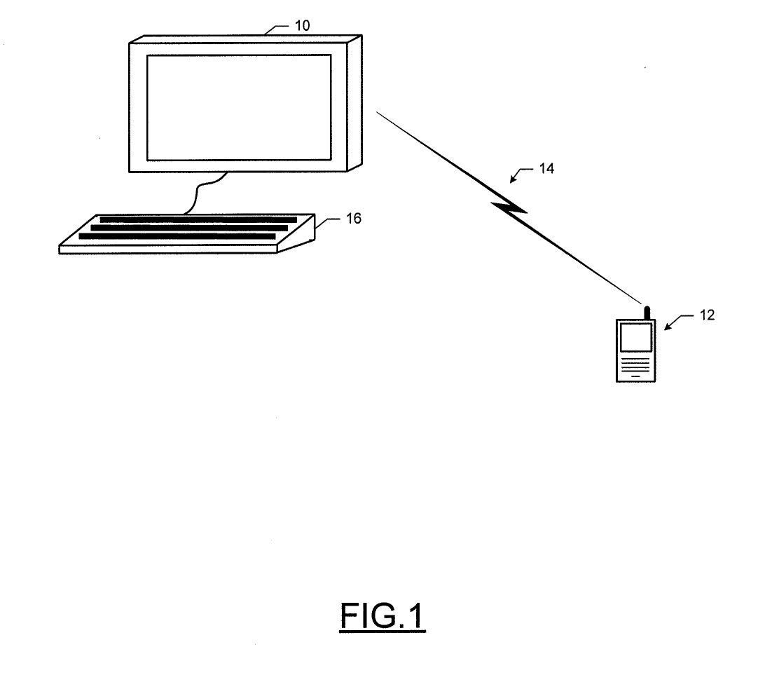

Some embodiments of the present invention may provide a mechanism by which improvements may be experienced in relation to the interoperability of mobile terminals with remote environments. In this regard, for example, a mobile terminal may be placed in communication with a remote device or environment and the mobile terminal and the remote environment may exchange information that directs the remote environment to display the same or at least a portion of the same user interface as that provided or generated by the mobile terminal. In this regard, FIG. 1 illustrates an example system in accordance with various example embodiments of the present invention. The example system includes a remote environment 10, a mobile terminal 12 and a communications link 14.

The remote environment 10 may include any type of computing device configured to display an image. According to some example embodiments, the remote environment may include user interface components and functionality, such as a screen on which to display the image. In this regard, keypad 16 may be an optional user input device, although other types of user input devices may be employed. For example, the screen may be a touch screen display that is configured to receive input from a user via touch events with the display. Further, the remote environment may include gaming controllers, speakers, a microphone, and the like. According to some example embodiments, the remote environment may be a system of devices that define an intelligent space. The system of devices may be configured to cooperate to perform various functionalities. For example, a remote environment implemented in a meeting room, a home living room, etc. may include a large screen monitor, a wired telephone device, a computer, and the like. The remote environment may also include a communications interface for communicating with the mobile terminal 12 via the communications link 14. By way of another example, the remote environment may include an in-car navigation system, a vehicle entertainment system, a vehicle head unit or any of a number of other remote environment with which the mobile terminal may communicate.

The communications link 14 may be any type communications link capable of supporting communications between the remote environment 10 and the mobile terminal 12. According to some example embodiments, the communications link is a wireless link, such as a wireless local area network (WLAN) link, a Bluetooth link, a WiFi link, an infrared link or the like. While the communications link is depicted as a wireless link, it is contemplated that the communications link may be a wired link, such as a Universal Serial Bus (USB) link or a High-Definition Multimedia Interface (HDMI) link. As described below, the communications link generally includes a plurality of different types of links. Consequently, the mobile terminal and the remote environment may each include a plurality of hardware interfaces, one of which is associated with and adapted for each of the communications links.

The mobile terminal 12 may be any type of mobile computing and communications device. According to various example embodiments, the mobile terminal is any type of user equipment, such as, for example, a personal digital assistant (PDA), wireless telephone, mobile computing device, camera, video recorder, audio/video player, positioning device (e.g., a GPS device), game device, television device, radio device, or various other like devices or combinations thereof. The mobile terminal may be configured to communicate with the remote environment 10 via the communications link 14. The mobile terminal may also be configured to execute and implement applications via a processor and memory included within the mobile terminal, as described below.

The interaction between the mobile terminal 12 and the remote environment 10 provides an example of mobile device interoperability, which may also be referred to as a smart space, remote environment, and remote client. In this regard, features and capabilities of the mobile terminal may be projected onto an external environment (e.g., the remote environment), and the external environment may appear as if the features and capabilities are inherent to external environment such that the dependency on the mobile terminal is not apparent to a user. According to various example embodiments, the mobile terminal may seamlessly become a part of the remote environment, whenever the person carrying the mobile device physically enters into the intelligent space (e.g., living room, meeting room, vehicle, or the like). Projecting the mobile terminal's features and capabilities may involve exporting the User Interface (UI) images of the mobile terminal, as well as command and control signals, to the external environment, whereby the user may comfortably interact with the external environment in lieu of the mobile terminal.

According to some example embodiments, the mobile terminal 12 may be configured to, via the communications link 14, direct the remote environment 10 to project a user interface image originating with the mobile terminal and receive user input provided via the remote environment. The image presented by the remote environment may be the same image or a portion of the same image that is being presented on a display of the mobile terminal, or an image that would have been presented had the display of the mobile terminal been activated. In some example embodiments, the image projected by the remote environment may be a modified image, relative to the image that would have been provided on the display of the mobile terminal. For example, consider an example scenario where the remote environment is installed in a vehicle as a vehicle head unit. The driver of the vehicle may wish to use the remote environment as an interface to the mobile terminal due, for example, to the convenient location of the remote environment within the vehicle and the size of the display screen provided by the remote environment. The mobile terminal may be configured to link with the remote environment, and direct the remote environment to present user interface images.

In an example embodiment, the remote environment 10 and the mobile terminal 12 may provide for virtual network computing (VNC) operation. As such, for example, the mobile terminal may serve as a VNC server configured to provide content originally executed or accessed by the mobile terminal to the remote environment acting as a VNC client (or vice versa). A VNC protocol such as RFB (remote frame buffer) or another protocol for enabling remote access to a graphical user interface may be utilized to provide communication between the mobile terminal and the remote environment.

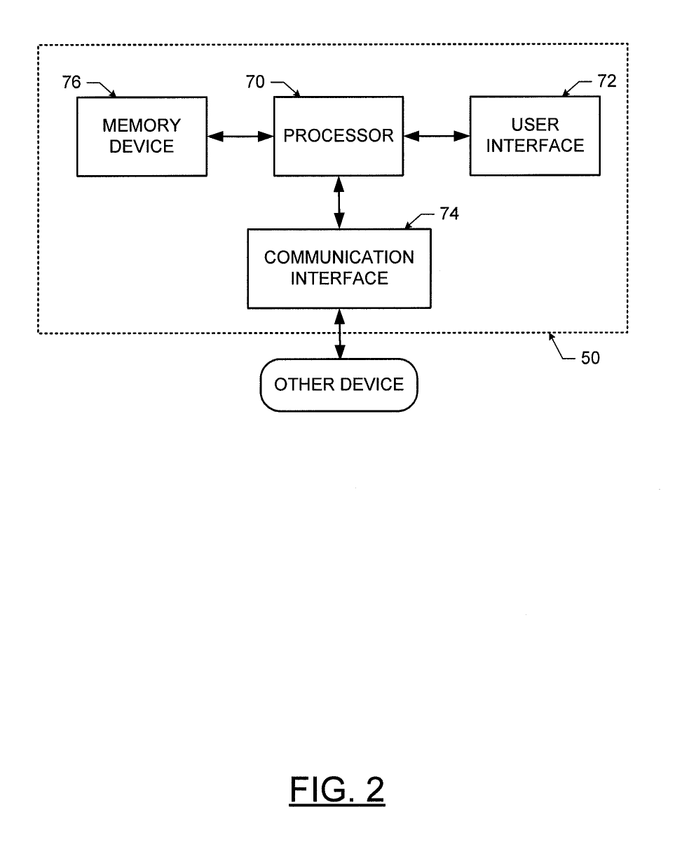

FIG. 2 illustrates a schematic block diagram of an apparatus 50 for facilitating interoperability between a mobile terminal 12 and a remote environment 10 according to an example embodiment of the present invention. The apparatus of FIG. 2 may be employed, for example, by the mobile terminal and/or the remote environment. However, it should be noted that the components, devices or elements described below may not be mandatory and thus some may be omitted in certain embodiments. Additionally, some embodiments may include further components, devices or elements beyond those shown and described herein. Furthermore, it should be noted that the terms “server device” and “client device” are simply used to describe respective roles that devices may play in connection with communication with each other. As such, a server device is not necessarily a dedicated server, but may be any device such as a mobile terminal that acts as a server relative to another device (e.g., a remote environment) receiving services from the server device. As such, the other device (e.g., the remote environment) may therefore be acting as a client device.

Referring now to FIG. 2, the apparatus 50 may include or otherwise be in communication with a processor 70, a user interface 72, a communication interface 74 and a memory device 76. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device). The memory device may be configured to store information, data, applications, instructions or the like for enabling the apparatus to carry out various functions in accordance with example embodiments of the present invention. For example, the memory device could be configured to buffer input data for processing by the processor. Additionally or alternatively, the memory device could be configured to store instructions for execution by the processor.

The processor 70 may be embodied in a number of different ways. For example, the processor may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an exemplary embodiment, the processor may be configured to execute instructions stored in the memory device 76 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., the mobile terminal 12 or the remote environment 10) adapted for employing embodiments of the present invention by further configuration of the processor by instructions for performing the algorithms and/or operations described herein. By executing the instructions or programming provided thereto or associated with the configuration of the processor, the processor may cause corresponding functionality to be performed. The processor may include, among other things, a clock, an arithmetic logic unit (ALU) and logic gates configured to support operation of the processor.

Meanwhile, the communication interface 74 may be any means such as a device or circuitry embodied in either hardware, or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. As described below, the communication interface may include a plurality of hardware interfaces for facilitating communication via different respective communication links 14. For example, the communication interface may include a WLAN interface, a Bluetooth interface, an infrared interface, a USB interface, an HDMI interface, etc.

The user interface 72 may be in communication with the processor 70 to receive an indication of a user input at the user interface and/or to provide an audible, visual, mechanical or other output to the user. As such, the user interface may include, for example, a keyboard, a mouse, a joystick, a display, a touch screen, soft keys, a microphone, a speaker, or other input/output mechanisms. In this regard, for example, the processor may comprise user interface circuitry configured to control at least some functions of one or more elements of the user interface, such as, for example, a speaker, ringer, microphone, display, and/or the like. The processor and/or user interface circuitry comprising the processor may be configured to control one or more functions of one or more elements of the user interface through computer program instructions (e.g., software and/or firmware) stored on a memory accessible to the processor (e.g., memory device 76, and/or the like).

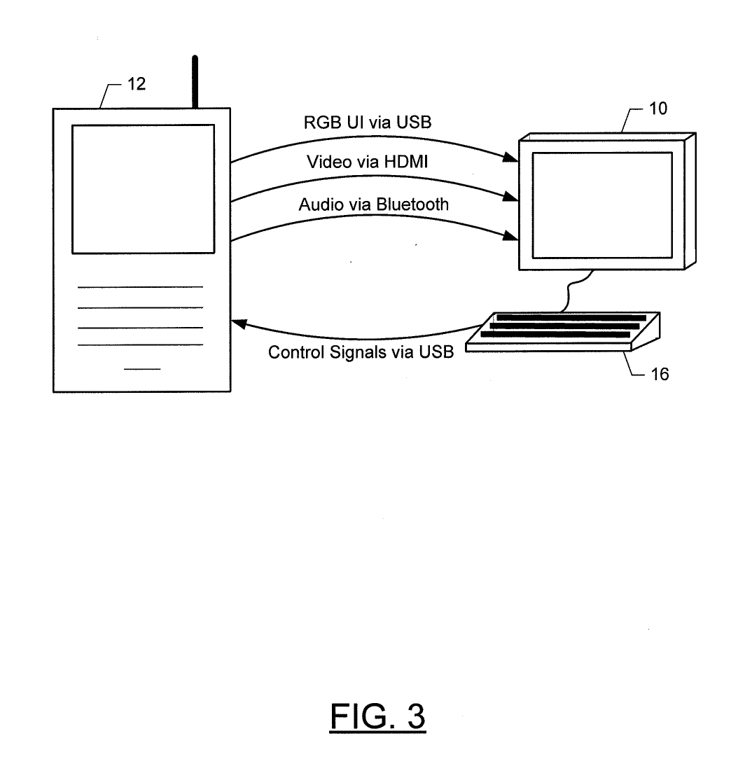

In an example embodiment depicted in FIG. 3, a mobile terminal 12 is desirous of interoperating with a remote environment 10. In a vehicular application, for example, the mobile terminal may be placed in a cradle within a vehicle such that the USB and HDMI interfaces of the mobile terminal are connected via wired communication links with respective USB and HDMI interfaces of a vehicular head end unit. Additionally, the mobile terminal may establish a wireless communication link, such as a WLAN, WiFi and/or a Bluetooth link, with the head end unit via respective WLAN, WiFi and/or Bluetooth interfaces.

In the embodiment of FIG. 3, the mobile terminal 12 may be configured such that content, such as the user interface, that is otherwise presented upon the display of the mobile terminal is alternatively or additionally presented upon the display in the remote environment. As such, a user may react to the content, such as the user interface, displayed in the remote environment, such as by making selections or otherwise providing control input via a user input device of the remote environment 10. The control input may, in turn, be provided by the remote environment to the mobile terminal such that the mobile terminal may thereafter respond appropriately to the control input.

The content that is to be provided from the mobile terminal 12 to the remote environment 10 may include a plurality of different components with each content component being of a different type. For example, the content may represent a unified user interface that includes an audio component, a video component, control signals and the like. Depending upon the type of content, each content component may have different network resource requirements that are necessary or desired to support the efficient transmission of the content component from the mobile terminal to the remote environment. While various network resource requirements may be defined, bandwidth, quality of service, latency and the like are examples of network resource requirements that may differ depending upon the type of content. Moreover, the mobile terminal and the remote environment may each include a variety of different hardware interfaces that support different types of communication links between the mobile terminal and the remote environment. As described above, for example, the mobile terminal and the remote environment may each include a WLAN interface, a Bluetooth interface, a WiFi interface, a USB interface, an HDMI interface and the like. Each hardware interface may also be configured to provide different levels of service or to otherwise provide access to different network resources, such as by providing different bandwidth, quality of service, latency, etc.

In order to facilitate the transfer of content, such as a unified user interface, between the mobile terminal 12 and the remote environment 10, the content, such as the entire user interface, e.g., video, audio, etc., may be split into different content components based upon the type of the content and the content components may then be assigned to or associated with different ones of the hardware interfaces based upon the network resource requirements of the content components and the network resources that may be provided by the different hardware interfaces. For example, the content components may be matched with respective hardware interfaces that satisfy the network resource requirements of the content components such that the content components may thereafter be transferred from the mobile terminal to the remote environment via the respective hardware interfaces in such a manner that the overall transfer is done in an efficient manner. By way of example, the entire unified user interface may be split into a user interface stream (which may, in turn, be further split into its constituent content components, e.g., video, audio, OpenGL commands, etc.) and a control stream with the user interface stream being transferred via the HDMI interface or an AV out interface, while the control stream is transferred via a Bluetooth stream or a WLAN stream. As a further example, the entire unified user interface may be split into a RGB user interface (UI) component, a video component and an audio component. Once encoded, these components may be transferred to the remote environment via different hardware interfaces, such as a USB interface for the RGB UI component, an HDMI interface for the video component and a Bluetooth interface for the audio component, as shown, for example, in FIG. 3. While examples of the different hardware interfaces are provided above, it should be understood that these hardware interfaces are simply examples and the content components may, instead, be assigned to or associated with different hardware components in other embodiments, such as by assigning the audio component to the WiFi interface or the USB interface. The remote environment may then receive the plurality of content components via the respective hardware interfaces and may recompose the content, such as the unified user interface. The recomposed content, such as the unified user interface, may then be displayed such that the user may have a comparable or even an improved user experience in the remote environment as compared to that otherwise provided by the mobile terminal.

The remote environment 10 may, in turn, provide content to the mobile terminal 12. For example, the remote environment may receive user input, such as via a user input device, and may provide the user input, such as via a control stream to the mobile terminal. As before, the remote environment may determine the appropriate hardware interface via which to transfer the control stream based upon the network resource requirements of the control stream and the network resources provided by the respective hardware interfaces. In the embodiment of FIG. 3, for example, the remote environment may provide the control stream via the USB interface, while the Bluetooth interface. However, the WLAN interface or other of the hardware interfaces may be utilized for the control stream in other embodiments. Additionally, the remote environment may provide feedback to the mobile terminal regarding the network performance in regards to the transfer of the content components from the mobile terminal to the remote environment. By way of example, the remote environment may provide data relating to the quality of service associated with the transfer of the content components via each of a plurality of different hardware interfaces. The mobile terminal, may, in turn, take the feedback, such as the quality of service data, into account in subsequently assigning content components to the respective hardware interfaces for transfer to the remote environment. By way of example, the audio component may initially be assigned to a Bluetooth interface that is utilized for streaming the audio, but the quality of service feedback of the Bluetooth and USB interfaces may indicate to the mobile terminal that the audio component should be reassigned to the USB interface during playback so as to provide better sound quality. Thus, the mobile terminal may either select the hardware interfaces via which to transfer the various content components based upon static rules or based on dynamic rules that may utilize, for example, feedback, such as quality of service data, provided by the remote environment or otherwise.

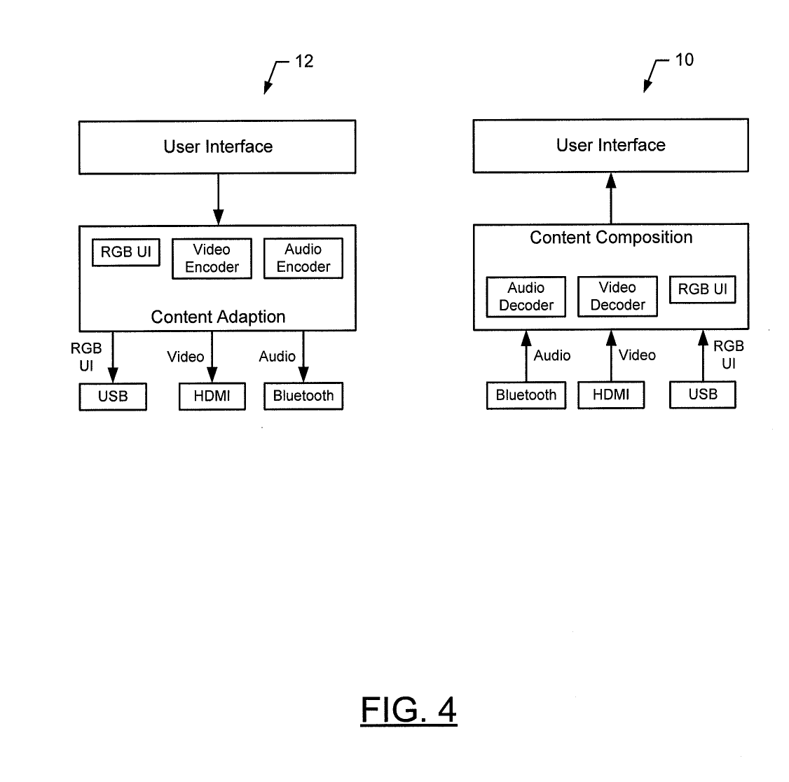

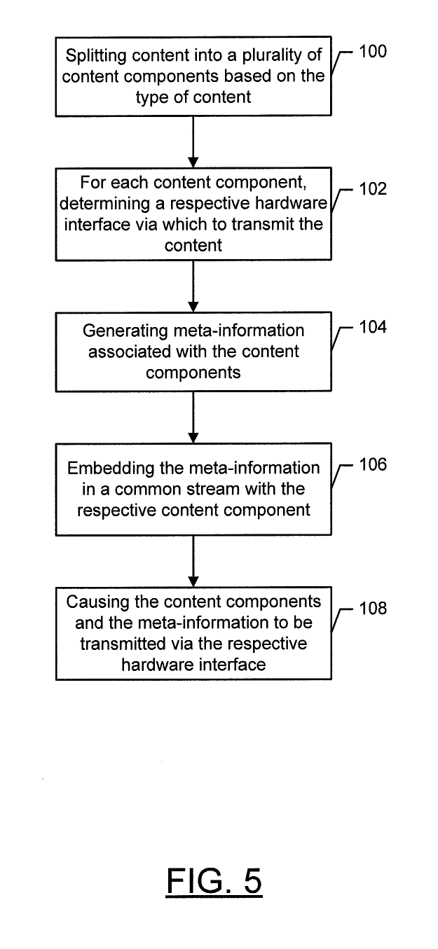

By way of further example, the operations associated with the interoperability of a mobile terminal 12 and a remote environment 10 in one embodiment are described in further detail below in conjunction with FIGS. 4-6. As shown in FIG. 4, the server device, such as the mobile terminal of one embodiment, may initially be presented with a unified user interface. This unified user interface may, but need not, be presented upon the display of the server device. As shown in FIG. 4 and in block 100 of FIG. 5, the apparatus 50 of the server device may include means, such as the processor 70, for implementing content adaptation by splitting the content, such as the unified user interface, into a plurality of content components based upon the content type such that each different type of content is segregated into a different component, such as by separating a control stream from a user interface stream. In the embodiment depicted in FIG. 4, for example, the unified user interface is split into three content components, namely, an RGB UI component, a video component and an audio component. As shown in FIG. 4, one or more of the content components, such as the video component and the audio component, may then be encoded.

The apparatus 50 of the server device may also include means, such as the processor 70, for determining, for each of the plurality of the content components, a respective hardware interface via which to transmit the content component. See block 102 of FIG. 5. In regards, to determining the respective hardware interface via which to transmit each content component, the network resource requirements, such as bandwidth, quality of service, latency, etc., for each content component may be determined. Additionally, the network resources that may be provided by each hardware interface may also be determined. As such, the apparatus may include means, such as the processor, for determining the content components to be assigned to the network interfaces based upon the network resource requirements of the content components and the network resources that may be provided by the hardware interfaces. As such, each content component may be assigned to a hardware interface that satisfies the network resource requirements of the respective content component, if possible. In embodiments in which the network resource requirements of a respective content component cannot be satisfied by the hardware interfaces, the apparatus, such as the processor, may assign the content components to respective hardware interfaces that most nearly satisfy the network resource requirements of the content components, that is, that minimize the difference between the network resource requirements of the content components and the network resources capable of being provided by the hardware interfaces.

In at least some embodiments, the server device, such as the mobile terminal 12, may also take into account feedback from the client device, such as the remote environment 10, such as in conjunction with the determination of the respective hardware interfaces via which to transmit the content components. As such, the apparatus 50 of the server device may also include means, such as the processor 70, for determining the respective hardware interfaces via which the content components are to be transmitted based upon the feedback, such as the quality of service of the respective hardware interfaces. Thus, the assignment process by which content components are assigned to respective hardware interfaces may evolve in accordance with the behavior of the network.

In addition to determining the hardware interface via which to transmit each content component, the apparatus 50 of the server device may include means, such as the processor 70, for generating meta-information associated with at least one of the content components. See block 104 of FIG. 5. In this regard, the meta-information may include information that facilitates the recomposition and synchronization of the content components by the client device, such as within the remote environment 10. Alternatively or additionally, the meta-information may include fiducial information which may, for example, inform the client device, such as the remote environment, regarding the location and geometry of the associated content and how the content may be integrated in the resulting user interface. For example, fiducial information may be a chroma-key or other type of meta-data for indicating where the content component should be rendered. The apparatus of one embodiment may also include means, such as the processor, for embedding meta-information within a common stream with the respective content component, that is, with the content component with which the meta-information is most closely associated. See block 106 of FIG. 5.

The apparatus 50 of the server device may then also include means, such as the processor 70, the communication interface 74 or the like, for causing the plurality of content components and the meta-information to be transmitted via respective hardware interfaces. See block 108 of FIG. 5. Indeed, at least two of the content components and, in one example embodiment, each of the content components, is caused to be transmitted via different hardware interfaces.

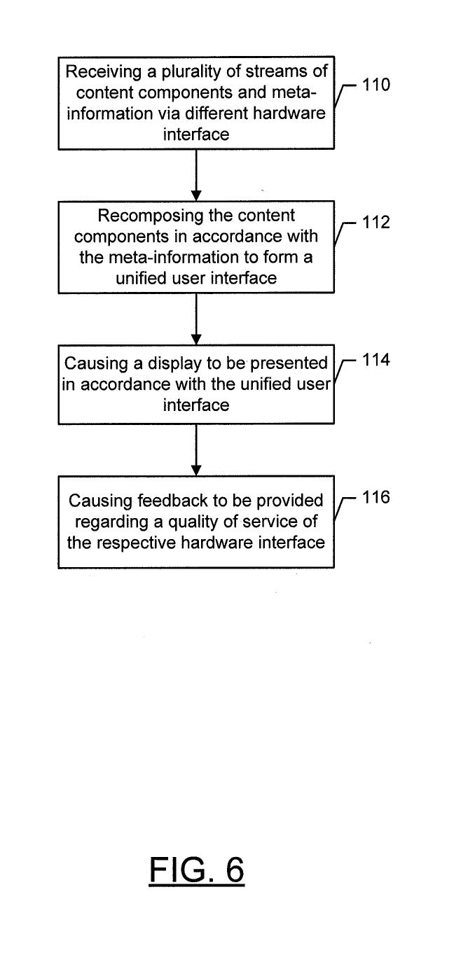

Following transmission of the content components, the client device, such as the remote environment 10, may include an apparatus 50 having means, such as the processor 70, the communication interface 74 or the like, for receiving the plurality of streams of content components and meta-information via the different respective hardware interfaces. See block 110 of FIG. 6. For example, the client device may receive a control stream and a user interface stream via different hardware interfaces. In the embodiments of FIGS. 3 and 4, for example, the audio component may be received via the Bluetooth interface, the video component may be received via the HDMI interface and the RGB user interface component may be received via the USB interface. If necessary or desired, one or more of the components, such as the audio component and/or the video component, may be decoded, such as shown in FIG. 4.

The apparatus 50 of the client device may also include means, such as the processor 70, for implementing content composition by recomposing the content components to the original content, such as a unified user interface. See block 112 of FIG. 6. In this regard, the processor may recompose the content component in accordance with the meta-information which may, for example, provide information regarding the composition and synchronization of the content components. Thereafter, the apparatus may include means, such as the processor, for causing a display to be presented in accordance with the recomposed content, such as the unified user interface. See block 114 of FIG. 6.

In one embodiment, the apparatus 50 of the client device may also include means, such as the processor 70, the communication interface 74 or the like, causing feedback, such as feedback regarding the quality of service of the respective hardware interfaces, to be provided to the server device. In this regard, the processor may determine a measure of the quality of service associated with the transfer of each content component via the respective hardware interface and may then provide such information to the server device for use, for example, in conjunction with the subsequent assignment of content components to the different hardware interfaces. The client device may also provide other signals, in addition to or instead of the feedback, to the server device. As shown in FIG. 3, the remote environment 10 of one embodiment may also include a user input device for receiving user input, such as control signals, that may, in turn, be provided to the mobile terminal 12 via a respective hardware interface, such as the USB, such that the mobile terminal may, in turn, take the desired action based upon the control signals provided by the user.

While primarily described above in conjunction with an embodiment in which the mobile terminal 10 functions as the server device and the remote environment 10 serves as the client device, the roles may be reversed in other embodiments with the remote environment functioning as the server device and the mobile terminal serving as the client device. In still further embodiments, other types of devices or terminals may serve as the server device and/or the client device.

As described above, FIGS. 4-6 are flowcharts of a system, method and program product according to example embodiments of the invention. It will be understood that each block of the flowchart, and combinations of blocks in the flowchart, may be implemented by various means, such as hardware, firmware, a processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 5 and 6 above may each comprise a processor (e.g., the processor 70) configured to perform some or each of the operations of the server device (100-108) or some or each of the operations of the client device (110-116) described above. The processors may, for example, be configured to perform the operations (100-108 or 110-116) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-108 may comprise, for example, the processor 70 of the apparatus 50 of the server device and/or a device or circuit for executing instructions or executing an algorithm for performing the functions of the server device as described above. Similarly, according to an example embodiment, examples of means for performing operations 110-116 may comprise, for example, the processor 70 of the apparatus 50 of the client device and/or a device or circuit for executing instructions or executing an algorithm for performing the functions of the client device as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining, with a processor for each of a plurality of content components of a user interface, a respective hardware interface via which to transmit the content component;
generating meta-information associated with at least one of the content components to facilitate recomposition of the content components following transmission; and
causing the plurality of content components and the meta-information to be transmitted via the respective hardware interfaces including causing at least two of the content components to be transmitted via different hardware interfaces.

2. A method according to claim 1 further comprising splitting a unified user interface into the plurality of content components based upon content type, prior to determining the respective hardware interfaces via which to transmit the content components.

3. A method according to claim 2 wherein splitting the unified user interface comprises separating a control stream from a user interface stream.

4. A method according to claim 1 further comprising embedding the meta-information in a common stream with the respective content component.

5. A method according to claim 1 wherein determining the respective hardware interfaces comprises determining the respective hardware interfaces based upon one or more network resource requirements of the respective content components.

6. A method according to claim 5 wherein determining the respective hardware interfaces further comprises determining the respective hardware interfaces based upon a quality of service of the respective hardware interfaces.

7. A method according to claim 1 further comprising receiving feedback regarding the respective hardware interfaces.

8. A method according to claim 7 wherein determining the respective hardware interfaces comprises determining the respective hardware interfaces at least partially based upon the feedback.

9. An apparatus comprising at least one processor and at least one memory including computer program code, the at least one memory and the computer program code configured to, with the processor, cause the apparatus to at least:
determine, for each of a plurality of content components of a user interface, a respective hardware interface via which to transmit the content component;
generate meta-information associated with at least one of the content components to facilitate recomposition of the content components following transmission; and
cause the plurality of content components and the meta-information to be transmitted via the respective hardware interfaces including to cause at least two of the content components to be transmitted via different hardware interfaces.

10. An apparatus according to claim 9 wherein the memory and computer program code are further configured to, with the processor, cause the apparatus to split a unified user interface into the plurality of content components based upon content type, prior to determining the respective hardware interfaces via which to transmit the content components.

11. An apparatus according to claim 10 wherein the memory and computer program code are further configured to, with the processor, cause the apparatus to split the unified user interface by separating a control stream from a user interface stream.

12. An apparatus according to claim 9 wherein the memory and computer program code are further configured to, with the processor, cause the apparatus to embed the meta-information in a common stream with the respective content component.

13. An apparatus according to claim 9 wherein the memory and computer program code are further configured to, with the processor, cause the apparatus to determine the respective hardware interfaces by determining the respective hardware interfaces based upon one or more network resource requirements of the respective content components.

14. An apparatus according to claim 13 wherein the memory and computer program code are further configured to, with the processor, cause the apparatus to determine the respective hardware interfaces by determining the respective hardware interfaces based upon a quality of service of the respective hardware interfaces.

15. An apparatus according to claim 9 wherein the memory and computer program code are further configured to, with the processor, cause the apparatus to receive feedback regarding the respective hardware interfaces.

16. An apparatus according to claim 15 wherein the memory and computer program code are further configured to, with the processor, cause the apparatus to determine the respective hardware interfaces by determining the respective hardware interfaces at least partially based upon the feedback.

17. A method comprising:
receiving a plurality of streams of content components and meta-information via different respective hardware interfaces;
recomposing, via a processor, the content components in accordance with the meta-information to form a unified user interface; and
causing a display to be presented in accordance with the unified user interface.

18. A method according to claim 17 wherein receiving the plurality of streams comprises receiving a control stream and a user interface stream via different hardware interfaces.

19. A method according to claim 17 further comprising causing feedback to be provided regarding a quality of service of the respective hardware interfaces.

20. A method according to claim 17 further comprising:
receiving an input; and
causing a signal based upon the input to be transmitted via a respective hardware interface.
